(19) United States
(12) Patent Application Publication
(10) Pub. No.: US 2025/0148199 A1
(43) Pub. Date: May 8, 2025

(54) GENERATING NATURAL LANGUAGE SUMMARIES OF MESSAGES USING LANGUAGE MODEL NEURAL NETWORKS

(71) Applicant: Google LLC, Mountain View, CA (US)

(72) Inventor: Gilman Edwin Tolle, San Francisco, CA (US)

(21) Appl. No.: 18/936,996

(22) Filed: Nov. 4, 2024

Related U.S. Application Data
(60) Provisional application No. 63/596,191, filed on Nov. 3, 2023.

(51) Int. Cl. G06F 40/20; H04L 51/21; H04N 21/4788

(52) U.S. Cl. CPC G06F 40/20; H04L 51/21; H04N 21/4788

(57) ABSTRACT

Methods, systems, and apparatus, including computer programs encoded on computer storage media, for generating natural language summaries of user messages using language model neural networks.

### BACKGROUND

This specification relates to generating text using neural networks.

Neural networks are machine learning models that employ one or more layers of nonlinear units to predict an output for a received input. Some neural networks include one or more hidden layers in addition to an output layer. The output of each hidden layer is used as input to or more other layers in the network, i.e., one or more other hidden layers, the output layer, or both. Each layer of the network generates an output from a received input in accordance with current values of a respective set of parameters.

### SUMMARY

This specification describes a system implemented as computer programs on one or more computers in one or more locations that generates, for each of multiple clusters of messages, a respective summary of the messages in the cluster using a language model neural network.

The subject matter described in this specification can be implemented in particular embodiments so as to realize one or more of the following advantages.

Many online environments maintain large collections of messages that include messages about many different topics, making it difficult for users to effectively interact with the collection of messages. For example, on a media sharing platform, popular media content items, e.g., videos, can have thousands of comments discussing many different topics—far too many for one person to read. However, viewers still want to know what people are talking about in the comments section, so they can figure out which conversations to contribute to. Additionally, media creators may want to know what people are talking about on their videos, so they can figure out who to respond to, collect feedback, and get inspired to create new videos.

However, extracting topics from a very large message corpus is difficult. Additionally, a given online environment can maintain a large number of different collections of documents that include messages about many different topics.

To address these issues, this specification describes techniques for performing clustering of a given collection of messages in an unsupervised manner. As a result of the clustering, the system partitions the collection of messages into a set of message clusters, each of which contains messages that are primarily about the same topic. However, the result of the clustering is simply a partitioning of the messages, rather than any kind of description of which topic is represented by a given cluster. To address this issue, the system uses a language model neural network to generate, from a subset of the messages in a given cluster, a readable and meaningful summary of the topic to which the messages in the given cluster relate. Thus, the system can generate, from a collection of documents and in an autonomous and unsupervised manner, a readable and meaningful summary for each of a set of topics and, for each topic, a set of messages that relate to the topic. The system can then present this information to a user, e.g., rather than requiring the user to directly review the large collection of messages. As a result, the system can present users with an effective view of the collection of messages even when the collection contains an exceedingly large number of messages about a large number of different topics.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example topic generation system.

FIG. 2 shows an example of the operation of the topic neural network system.

FIG. 3 is a flow diagram of an example process for generating summaries of clusters of messages.

FIG. 4 is a flow diagram of an example process for generating summaries of comments on a particular media content item.

FIG. 5 shows examples of user interfaces that can be provided for presentation by the system.

Like reference numbers and designations in the various drawings indicate like elements.

### DETAILED DESCRIPTION

This specification describes a system implemented as computer programs on one or more computers in one or more locations that organizes a collection of messages into topics and then presents the messages in a user interface according to the topics.

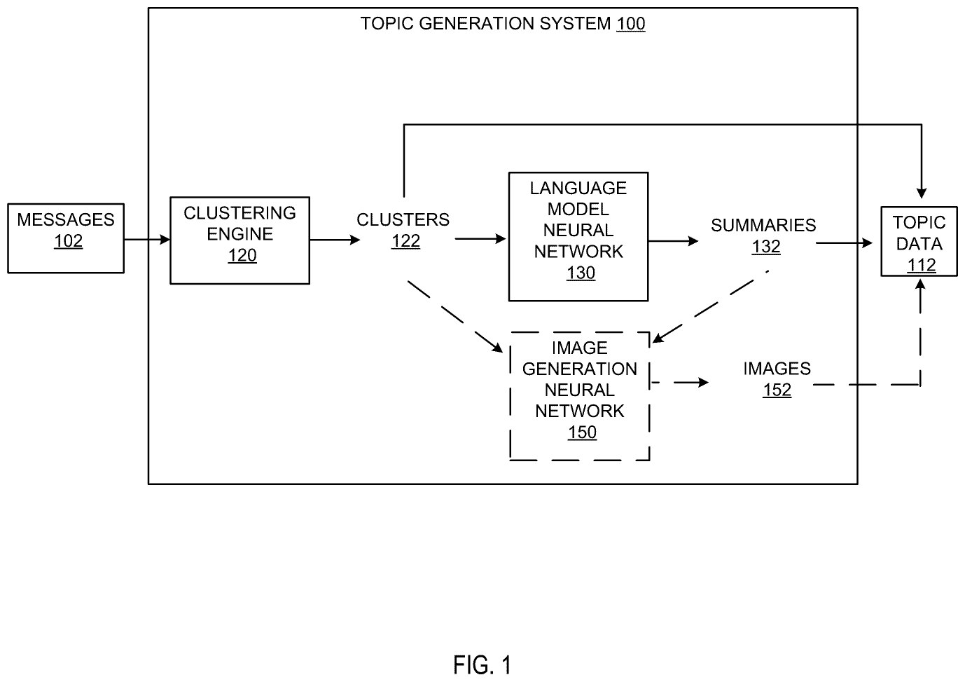

FIG. 1 is a diagram of an example topic generation system 100. The topic generation system 100 is an example of a system implemented as computer programs on one or more computers in one or more locations, in which the systems, components, and techniques described below can be implemented.

The system 100 receives a collection of messages 102. Generally, the collection of messages 102 is a collection of messages that have been submitted by users.

The messages in the collection of messages can be any appropriate type of communication that includes text.

For example, the messages 102 can be comments that have been submitted by users about a particular content item.

As a particular example, the particular content item can be a media content item, e.g., a video, a song or other musical composition, and so on, that is hosted on a media sharing platform.

As another example, the messages 102 can be comments that have been submitted by users about a live media stream on a media streaming platform (which can be the same platform as, or a different platform from, the media sharing platform).

As another example, the messages 102 can be posts by users to an online community, e.g., a message board, a micro-blogging platform, and so on.

As yet another example, the messages 102 can be product reviews or other messages submitted by users about an entity, e.g., a product that is available for sale on a given online marketplace, a business that is listed on a given online platform, and so on.

The system 100 processes the collection of messages 102 to generate topic data 112 that associates, for each of multiple topics, a natural language summary 132 of the topic with a corresponding subset of the collection of messages 102 that are about the topic.

The system 100 then uses the topic data 112 to organize the messages 102 when they are presented to a user, e.g., a user of the media sharing platform, the online community, the online marketplace, or the online platform, for viewing the messages 102.

In particular, the system 100 uses a clustering engine 120 to cluster the collection of messages 102 into multiple clusters 122 that each include a respective subset of the collection of messages 102.

The clustering engine 120 can generally use any appropriate clustering technique in order to cluster the messages 102 into the multiple clusters 122.

As a particular example, the clustering engine 120 can process each message in the collection of messages 102 using a text embedding neural network to generate a respective embedding of each of the messages.

An “embedding” as used in this specification is an ordered collection of numerical values having a fixed dimensionality, e.g., a vector of floating point or other numerical values. That is, the embeddings of two different messages in the collection will generally be different but will have the same number of numerical values.

For example, the text embedding neural network can be, e.g., an encoder-only Transformer neural network, an encoder-decoder Transformer neural network, a decoder-only Transformer neural network, or a recurrent neural network that has been trained to generate semantically meaningful embeddings. For example, the text embedding neural network can have been trained on an unsupervised representation learning objective, e.g., a language modeling objective, a masked language modeling objective, a bi-directional encoder representations (BERT) objective, and so on.

The clustering engine 120 can then apply an appropriate clustering algorithm to the embeddings of the messages in the collections in order to cluster the collection of messages 102 into the multiple clusters 122. Examples of clustering algorithms include agglomerative clustering algorithms, k-means algorithms, mean shift clustering algorithms, hierarchical clustering algorithms, and so on.

Optionally, the system 100 can filter the set of clusters 122 after applying the clustering algorithm, e.g., so that the clustering algorithm generates an initial set of clusters and the system 100 filters the initial set of clusters to generate the set of clusters 122. For example, the system 100 can filter the set of clusters 122 by removing any cluster that does not contain more than a threshold number of messages.

The system 100 then generates, for each cluster 122, a respective natural language summary 132 of the messages in the cluster using a language model neural network 130.

For example, the language model neural network 130 can be a large language model (“LLM”) that is configured to process an input sequence of tokens from a vocabulary of text tokens to generate an output sequence of tokens from vocabulary.

More generally, the language model neural network 130 can be any appropriate neural network that receives an input sequence made up of text tokens selected from a vocabulary and auto-regressively generates an output sequence made up of text tokens from the vocabulary. For example, the language model neural network can be a Transformer-based language model neural network or a recurrent neural network-based language model neural network.

In some situations, the language model neural network 130 can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the language model neural network can process the current input sequence to generate a score distribution (e.g., a probability distribution) that assigns a respective score, e.g., a respective probability, to each token in the vocabulary of tokens. The language model neural network can then select, as the particular token, a token from the vocabulary using the score distribution. For example, the neural network of the language model can greedily select the highest-scoring token or can sample, e.g., using nucleus sampling or another sampling technique, a token from the distribution.

As a particular example, the language model neural network 130 can be an auto-regressive Transformer-based neural network that includes (i) a plurality of attention blocks that each apply a self-attention operation and (ii) an output subnetwork that processes an output of the last attention block to generate the score distribution.

The language model neural network 130 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

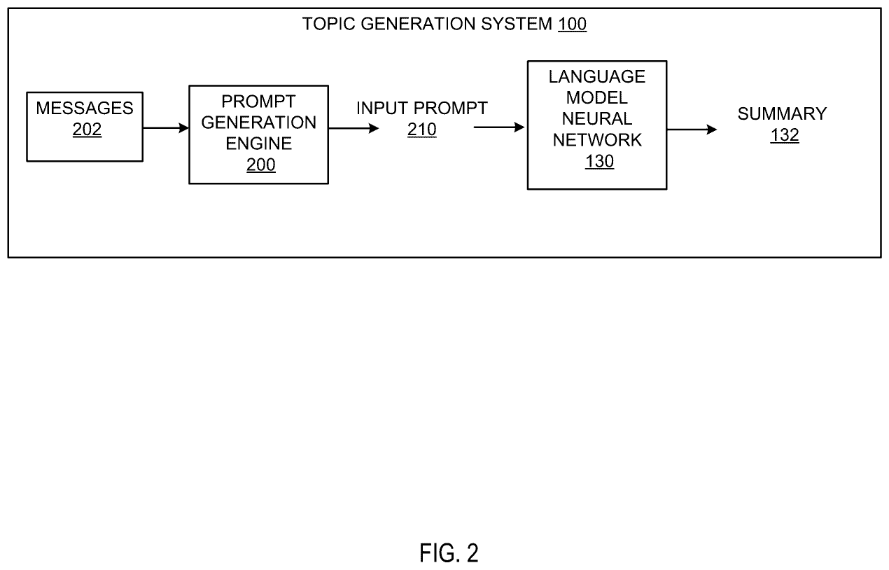

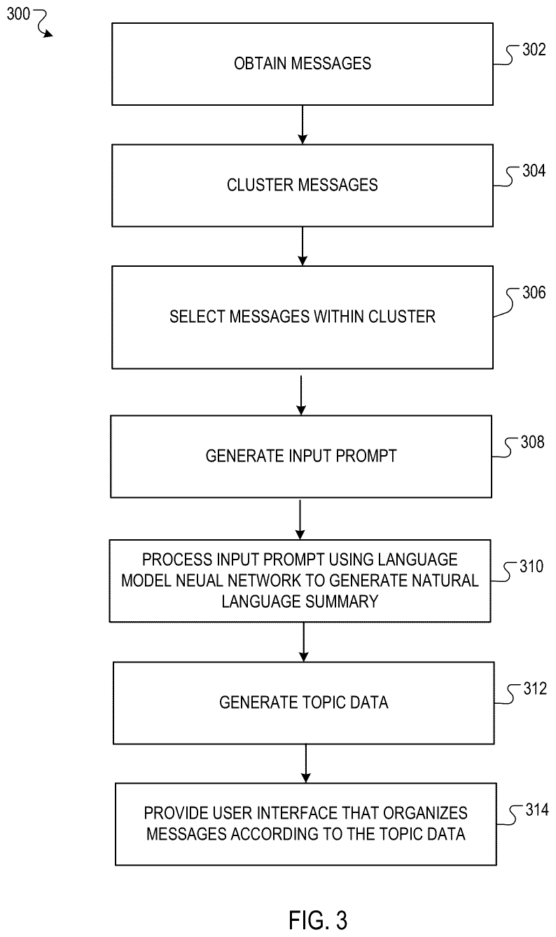

Generating a natural language summary of a cluster of messages using a language model neural network is described in more detail below with reference to FIGS. 2 and 3.

The system 100 then generates the topic data 112 by associating, for each cluster 122, the natural language summary 132 of the cluster 122 with the messages in the cluster 122.

Thus, while the clustering applied by the clustering engine 120 can group the messages in the collection 102 so that messages within a given cluster have similar semantics, the system 100 uses the language model neural network 130 to generate a meaningful summary that can inform users what topic the messages in a given cluster relate to.

When a user requests to view the collection of messages 102, the system 100 can use the topic data 112 to organize the messages 102 by topic when presented to the user.

For example, the system 100 can provide, for presentation in a user interface on a user device, the natural language summaries for some or all of the clusters.

When presented, each summary can be associated with a control element that, when selected, modifies the user interface to display the messages in the corresponding cluster. For example, the summaries can be displayed as text overlaid over the control elements.

Thus, rather than viewing individual messages, the user can first view the natural language summaries that describe the various topics of the messages and can then navigate to the messages that are about a desired topic by selecting the control element that is associated with the corresponding natural language summary.

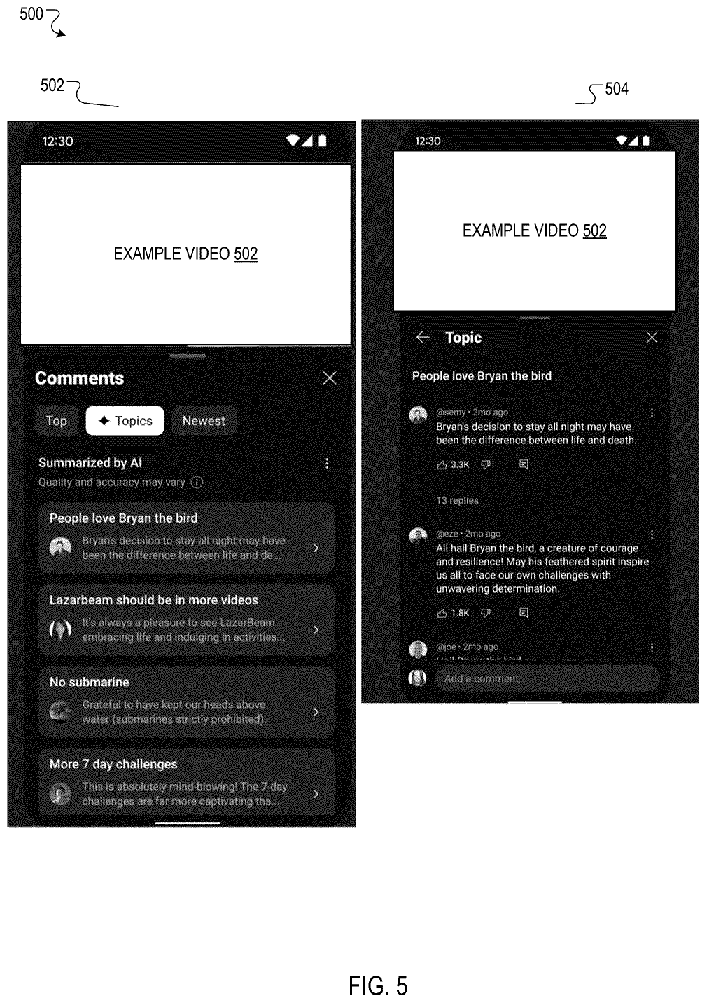

Examples of user interfaces are described below with reference to FIG. 5.

Optionally, the system 100 can also generate, for each cluster, an image 152 that visually describes the contents of the messages in the cluster.

In particular, for each cluster, the system 100 can generate a prompt for an image generation neural network 160 from the messages in the cluster, the natural language summary of the cluster, or both. The system 100 can then process the prompt using the image generation neural network 160 to generate, as output, an image 152 that describes the cluster.

The system 160 can use any appropriate generative neural network to generate the image 152.

For example, the system 100 can use a diffusion neural network to generate the image 152. One example of such a neural network is a latent diffusion model, e.g., MobileDiffusion. Another example of such a neural network is a diffusion model that uses a text-to-image diffusion model to generate a first image, and then applies one or more super-resolution diffusion models to generate the final image 152. One example of such a model is Imagen.

As another example, the system 100 can use an auto-regressive generative model to generate the image 152. One example of such a model is Parti.

As yet another example, the system 100 can use a masked token generative model that sequentially unmasks visual tokens during generation to generate the image 152. One example of such a generative model is Muse.

The system 100 can then associate, within the topic data 112, the image for the cluster with the summary for the cluster and the messages for the cluster.

When images 152 are generated, the system can provide the images 152 for presentation along with the natural language summary as a description of the corresponding topic.

FIG. 2 shows an example of the operation of the system 100 when generating a natural language summary of a given cluster of messages 202.

In particular, as shown in FIG. 2, the system 100 includes a prompt generation engine 200 and the language model neural network 130.

To generate the natural language summary of the given cluster, the prompt generation engine 200 processes the messages in the cluster to generate an input prompt 210 for the language model neural network 130.

The input prompt 210 is an input sequence of tokens to the language model neural network 130 that causes the language model neural network 130 to generate, as output, the natural language description of the cluster.

In particular, the prompt generation engine 200 can select a subset of the messages in the cluster and then generate the input prompt 210 using the selected subset of messages.

For example, the input prompt 210 can include the selected subset of messages and a natural language instruction to summarize the content of the selected subset of messages.

As one example, the input prompt 210 can be of the form “Please generate a short plain language summary of the main theme of the following messages: [A]; [B]; [C]” or of the form “Please summarize the contents of the following messages in less than ten words: [A]; [B]; [C],” where A, B, and C represent the selected subset of messages.

The system 100 can select the subset of messages from the cluster in any of a variety of ways.

As one example, the system 100 can randomly select a fixed number of messages from the cluster.

As another example, the system 100 can rank the messages in the cluster according to one or more signals and then select a fixed number of highest-ranked messages from the cluster.

FIG. 3 is a flow diagram of an example process 300 for generating natural language summaries of clusters of user messages. For convenience, the process 300 will be described as being performed by a system of one or more computers located in one or more locations. For example, a topic generation system, e.g., the topic generation system 100 depicted in FIG. 1, appropriately programmed in accordance with this specification, can perform the process 300.

The system obtains a plurality of messages (step 302).

The messages can be any appropriate type of communication that includes text.

For example, the messages can be comments that have been submitted by users about a particular content item. As a particular example, the particular content item can be a media content item, e.g., a video, a song or other musical composition, and so on, that is hosted on a media sharing platform.

As another example, the messages can be comments that have been submitted by users about a live media stream on a media streaming platform (which can be the same platform as, or a different platform from, the media sharing platform).

As another example, the messages can be posts by users to an online community, e.g., a message board, a micro-blogging platform, and so on.

As yet another example, the messages can be product reviews or other messages submitted by users about an entity, e.g., a product that is available for sale on a given online marketplace, a business that is listed on a given online platform, and so on.

The system clusters the messages into a plurality of clusters (step 304). As described above, the system can generally use any appropriate clustering technique in order to cluster the messages into the multiple clusters.

In some cases, the system can use the clustering technique to cluster the messages into an initial set of clusters and then filter the initial set of clusters to generate a final set of clusters.

For example, the system can filter out any cluster that has fewer than a threshold number of messages.

As another example, the system can rank the clusters based on signals for the messages in the clusters.

That is, the system can assign each cluster a score based on one or more signals for the messages in the cluster and then rank the clusters according to the assigned scores. The system can then filter output all of the clusters except (i) a fixed number of clusters with the highest scores or (ii) each cluster that has an assigned score that is above a threshold.

As described below, a signal for a message is a score that measures a corresponding property of the message. The system can determine a score for a cluster from one or more signals for each of the messages in the cluster in any of a variety of ways. As one example, when there is more than one signal, the system can compute a combined score for each message in the cluster, e.g., as a sum or a weighted sum of the signals for the messages, and then compute the score for the cluster as a measure of central tendency, e.g., arithmetic mean, geometric mean, or median, of the combined scores of the messages in the cluster.

The system then performs steps 306-310 for each of the clusters.

The system selects a plurality of the messages within the cluster (step 306).

As one example, the system can randomly select a fixed number of messages from the cluster.

As another example, the system can rank the messages in the cluster according to one or more signals and then select a fixed number of highest-ranked messages from the cluster.

Generally, each of the one or more signals is a score that measures a corresponding property of the message. When there is more than one signal, the system can compute a combined score for each message, e.g., as a sum or weighted sum of the signals, and rank the messages by the combined score.

As one example, the set of one or more signals can include a signal that measures the quality of the message.

As another example, the set of one or more signals can include a signal that measures user engagement with the message.

As another example, the set of one or more signals can include a signal that measures the relevance of the message to the content item to which the collection of messages relates.

The system generates an input prompt for a language model neural network from the selected messages (step 308). Generally, the input prompt can include the selected subset of messages and a natural language instruction to summarize the content of the selected subset of messages.

The system processes the input prompt using the language model neural network to generate a natural language summary of the cluster (step 310).

Optionally, the system can then apply one or more criteria to the summary to determine whether to keep or discard the summary. As one example, the system can determine whether the summary matches, i.e., is semantically equivalent to, another summary for another cluster. If so, the system can discard the summary and, optionally, the corresponding cluster. As another example, the system can determine whether the summary meets an appropriateness criterion. If not, the system can discard the summary and, optionally, the corresponding cluster.

The system generates topic data that associates, for each cluster, the natural language summary of the cluster with the messages within the cluster (step 312).

The system provides, for presentation on a user device, a user interface that organizes the messages according to the topic data (step 314). That is, the system can provide the user interface in response to a user request to access the messages or in response to a user request to view the content item to which the messages correspond. An example of a user interface will be described below with reference to FIG. 5.

Generally, once the system has performed the process 300 to generate the topic data, the system can continue receiving messages. For example, users can continue making posts on an online community or leaving comments on a particular media content item even after the initial iteration of the process 300 has been performed.

In these cases, the system can update the topic data as new messages are received.

For example, once a first threshold number of messages have been received after the most recent time that the topic data has been updated, the system can cluster each new message that has been received since the topic data was last updated into one of the existing clusters and then update the topic data to associate the new messages with the corresponding cluster.

As another example, once a second threshold number of messages have been received or another appropriate criterion has been satisfied, the system can repeat steps 306 and 308 to generate new summaries for each of the clusters and update the topic data to replace the existing summaries with the new summaries. Thus, when the receipt of new messages causes the system to select different messages within a given cluster, the system can update the natural language summary of the cluster to one that better reflects the updated contents of the messages in the given cluster.

As yet another example, once a third threshold number of messages have been received or another appropriate criterion has been satisfied, the system can repeat steps 304-312 to update the clustering. That is, the system can re-cluster the messages to incorporate the impact of the new messages on the potential clustering.

As described above, in some cases, the messages are user comments on a media content item hosted by a media sharing platform, e.g., on a video hosted by the media sharing platform.

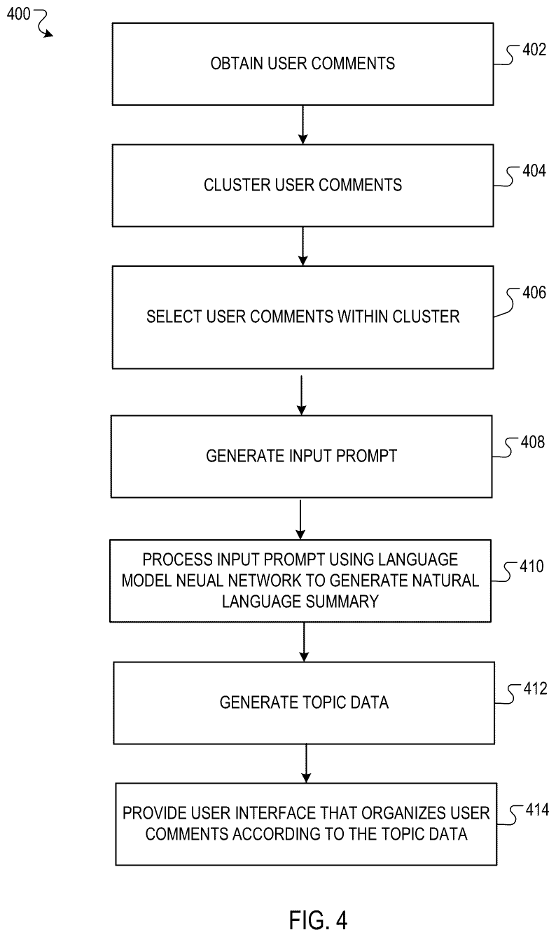

FIG. 4 is a flow diagram of an example process 400 for generating natural language summaries of clusters of user comments on a media content item. For convenience, the process 400 will be described as being performed by a system of one or more computers located in one or more locations. For example, a topic generation system, e.g., the topic generation system 100 depicted in FIG. 1, appropriately programmed in accordance with this specification, can perform the process 400.

The system obtains a plurality of user comments (step 402). For example, the user comments can be all of the user comments that have been submitted to the media sharing platform about the media content item and that satisfy one or more criteria.

For example, the criteria can include a criterion on age of the comment, i.e., how long ago the comment was submitted.

As another example, the criteria can include a criterion on quality of the comment, e.g., a criterion that measures relevance of the comment to the media content item, that measures legibility of the comment, or both.

As yet another example, the criteria can include a criterion on appropriateness of the comment, e.g., a criterion that measures whether the user comment is appropriate to display to other users.

As yet another example, the criteria can include a criterion that requires that the comment relate to a particular focus area within the media content item, e.g., a particular product, person, or other entity. For example, the system can run a classifier on the set of comments on the entire media content item that is configured to classify the comments as either relating to the particular focus area or not.

The system clusters the user comments into a plurality of clusters (step 404).

The system then performs steps 406-410 for each of the clusters.

The system selects a plurality of the messages within the cluster (step 406).

The system generates an input prompt for a language model neural network from the selected messages (step 408).

The system processes the input prompt using the language model neural network to generate a natural language summary of the cluster (step 410).

In some implementations, prior to using the output of the language model neural network as the natural language summary of the cluster, the system can determine whether the output satisfies one or more criteria.

For example, the criteria can include a criterion on appropriateness of the output, e.g., a criterion that measures whether the output is appropriate to display to users.

As another example, the criteria can include a criterion on quality of the output, e.g., a criterion that measures legibility of the output.

If the output does not satisfy the criteria, the system can, for example, sample another output from the language model neural network and continue sampling until an output that satisfies the criteria is generated or can remove the cluster from the set of clusters.

The system generates topic data that associates, for each cluster, the natural language summary of the cluster with the messages within the cluster (step 412).

The system provides, for presentation on a user device, a user interface that organizes the messages according to the topic data (step 414).

FIG. 5 shows an example 500 of user interfaces 510 and 520 that can be provided by presentation by the system.

In the example of FIG. 5, the messages are user comments about a video content item 502.

In particular, as shown in FIG. 5, the system provides a user interface 510 that allows a user to playback the video 502 and that shows comments users have provided about the video.

The user interface 510 includes a user interface element “topics” that, when selected, presents the comments organized by topic. In other words, upon the user selecting the user interface element “topics,” the user interface 510 presents the natural language summaries generated by the system 100, e.g., ranked according to one or more signals. In the example of FIG. 5, the user interface 510 presents the natural language summaries of three clusters of messages. The user interface 510 also presents, for each natural language summary, an associated user interface element that can be selected by the user and that causes the user comments that are in the corresponding cluster to be displayed. For example, the user may be able to submit an input selecting the text of any given natural language summary in order to cause the user comments that are in the corresponding cluster to be displayed.

The user interface 520 is an example of a user interface that is presented once the user has selected a user interface element associated with an example natural language summary “People love Bryan the bird.”

In particular, the user interface 520 shows the video content item 502 and the comments that are in the cluster corresponding to the selected natural language summary. For example, the comments can be presented according to a ranking of the comments within the cluster. As a particular example, the system can rank the comments within the cluster according to one or more signals, e.g., signals that measure any of comment quality, appropriateness, popularity, and so on.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as summaries of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a plurality of messages;
clustering the messages into a plurality of clusters;
for each of the clusters:
selecting a plurality of the messages within the cluster;
generating a first input prompt for a language model neural network from the selected messages; and
processing the first input prompt using the language model neural network to generate a natural language summary of the cluster;
generating data that associates, for each cluster, the natural language summary of the cluster with the messages within the cluster; and
providing, for presentation on a user device, a user interface that presents the natural language summaries for the clusters.

2. The method of claim 1, wherein:
each of the plurality of messages is a respective user comment associated with a particular content item.

3. The method of claim 2, wherein the particular content item is a media content item hosted on a media sharing platform.

4. The method of claim 3, wherein the particular content item is a video.

5. The method of claim 3, wherein providing, for presentation to a user, a user interface that presents the natural language summaries for the clusters:
providing, for presentation to the user on a user device, a user interface that displays the particular content item and the natural language summaries of the clusters and that includes, for each natural language summary, a control element that, when selected by the user, modifies the user interface to display at least a portion of the messages within the corresponding cluster.

6. The method of claim 1, wherein clustering the messages into a plurality of clusters comprises:
generating a respective embedding of each of the plurality of messages; and
clustering, using the respective embeddings of the plurality of messages, the messages into the plurality of clusters.

7. The method of claim 6, further comprising:
receiving a new message;
generating a new embedding of the new message;
adding, using the new embedding, the new message to a particular one of the plurality of clusters; and
updating the data to include the new message with the particular cluster and associate the new message with the respective natural language summary for the particular cluster.

8. The method of claim 1, wherein selecting a plurality of the messages within the cluster comprises:
ranking the messages within the cluster according to one or more signals; and
selecting a fixed number of highest-ranked messages in the ranking.

9. The method of claim 1, further comprising, for each cluster:
generating a second input prompt for an image generation neural network from (i) the messages within the cluster, (ii) the natural language summary of the cluster, or (iii) both; and
processing the second input prompt using the image generation neural network to generate an image that describes the cluster.

10. A system comprising:
one or more computers; and
one or more storage devices storing instructions that, when executed by the one or more computers, cause the one or more computers to perform operations comprising:
obtaining a plurality of messages;
clustering the messages into a plurality of clusters;
for each of the clusters:
selecting a plurality of the messages within the cluster;
generating a first input prompt for a language model neural network from the selected messages; and
processing the first input prompt using the language model neural network to generate a natural language summary of the cluster;
generating data that associates, for each cluster, the natural language summary of the cluster with the messages within the cluster; and
providing, for presentation on a user device, a user interface that presents the natural language summaries for the clusters.

11. The system of claim 10, wherein:
each of the plurality of messages is a respective user comment associated with a particular content item.

12. The system of claim 11, wherein the particular content item is a media content item hosted on a media sharing platform.

13. The system of claim 12, wherein the particular content item is a video.

14. The system of claim 12, wherein providing, for presentation to a user, a user interface that presents the natural language summaries for the clusters:
providing, for presentation to the user on a user device, a user interface that displays the particular content item and the natural language summaries of the clusters and that includes, for each natural language summary, a control element that, when selected by the user, modifies the user interface to display at least a portion of the messages within the corresponding cluster.

15. The system of claim 10, wherein clustering the messages into a plurality of clusters comprises:
generating a respective embedding of each of the plurality of messages; and
clustering, using the respective embeddings of the plurality of messages, the messages into the plurality of clusters.

16. The system of claim 15, the operations further comprising:
receiving a new message;
generating a new embedding of the new message;
adding, using the new embedding, the new message to a particular one of the plurality of clusters; and
updating the data to include the new message with the particular cluster and associate the new message with the respective natural language summary for the particular cluster.

17. The system of claim 10, wherein selecting a plurality of the messages within the cluster comprises:
ranking the messages within the cluster according to one or more signals; and
selecting a fixed number of highest-ranked messages in the ranking.

18. The system of claim 10, the operations further comprising, for each cluster:
generating a second input prompt for an image generation neural network from (i) the messages within the cluster, (ii) the natural language summary of the cluster, or (iii) both; and
processing the second input prompt using the image generation neural network to generate an image that describes the cluster.

19. One or more non-transitory computer-readable storage media storing instructions that when executed by one or more computers cause the one or more computers to perform operations comprising:
obtaining a plurality of messages;
clustering the messages into a plurality of clusters;
for each of the clusters:
selecting a plurality of the messages within the cluster;
generating a first input prompt for a language model neural network from the selected messages; and
processing the first input prompt using the language model neural network to generate a natural language summary of the cluster;
generating data that associates, for each cluster, the natural language summary of the cluster with the messages within the cluster; and
providing, for presentation on a user device, a user interface that presents the natural language summaries for the clusters.

20. The computer-readable storage media of claim 19, wherein:
each of the plurality of messages is a respective user comment associated with a particular content item.
